(19) United States
(12) Patent Application Publication
(10) Pub. No.: US 2015/0217342 A1
(43) Pub. Date: Aug. 6, 2015

(54) SEAL ASSEMBLY USEFUL IN CLEANER FOR TUBULARS

(71) Applicants: DOUGLAS H. WHITSITT, SPRING, TX (US); LOUIS P. VICKIO, JR., HOUSTON, TX (US)

(72) Inventors: DOUGLAS H. WHITSITT, SPRING, TX (US); LOUIS P. VICKIO, JR., HOUSTON, TX (US)

(21) Appl. No.: 14/172,007

(22) Filed: Feb. 4, 2014

(51) Int. Cl. B08B 9/055; F16L 21/02

(52) U.S. Cl. CPC B08B 9/055; F16L 21/02

(57) ABSTRACT

There is provided an elastomeric annular seal having a chamfered first end and a chamfered second end and a generally cylindrical outer surface extending between the first end and the second end. Preferably, the elastomeric annular seal is mounted on a rigid sleeve. The seal has annular cross sections to fit the sleeve and the chamfers are radiused when viewed in longitudinal section so that the radiused chamfered ends of the elastomeric annular seal together with the outside surface of the rigid sleeve form annularly shaped cups. Fluid pressure in the cup will expand the seal against the inside wall of a tubular when the seal/sleeve is appropriately sized for the tubular in which it is deployed.

### FIELD OF THE INVENTION

The present invention relates to an elastomeric annular seal and seal assembly useful, for example, for fitting to a cleaning device for tubulars, to provide a fluid seal between the device and the tubular being cleaned.

### BACKGROUND OF THE INVENTION

The disclosure of U.S. Pat. No. 8,316,501, patented Nov. 27, 2013 is incorporated herein by reference.

The device shown in U.S. Pat. No. 8,316,501 is used to clean various types of tubulars. The device is equipped with one or more annular seals to prevent fluids from leaking past the device during cleaning or recovery operations. However, when the device is used to clean welded tubulars, such as pipelines, radially inwardly projecting rings or elements of weld bead are encountered as the device progresses through the pipeline. As the device squeezes past these rings of weld bead, the annular seals are damaged, permitting leakage past the seals which reduces the efficacy of the seals. What is needed is an annular seal system that is resistant to damage from the beads.

### Objects of the Invention

It is an object of this invention to provide an annular seal system for a pipeline cleaner that is resistance to damage from weld beads on the inside wall of the pipeline.

### SUMMARY OF THE INVENTION

In one embodiment of the invention, there is provided an elastomeric annular seal having a chamfered first end and a chamfered second end and a generally cylindrical outer surface extending between the first end and the second end.

When deployed on an appropriately sized tubular element in a tubular, the chamfered areas seal positively against annular fluid flow from either direction between the tubular element and the tubular.

In another embodiment of the invention, the elastomeric annular seal is mounted on a rigid sleeve. The seal has annular cross sections to fit the sleeve and the chamfers are radiused when viewed in longitudinal section so that the radiused chamfered ends of the elastomeric annular seal together with the outside surface of the rigid sleeve form annularly shaped cups. Fluid pressure in the cup will expand the seal against the inside wall of a tubular when the seal/sleeve is appropriately sized for the tubular.

In a further embodiment of the invention, the seal/sleeve ends are slightly asymmetric. A first end of the rigid sleeve is slightly recessed with respect to a first end of the elastomeric annular seal, and the second end of the rigid sleeve slightly protrudes with respect to the second end of the elastomeric seal. When first and second such seal/sleeve combinations are mounted in a stack on a cylindrical surface with the rigid sleeves in abutting relationship, first end to second end, an annular gap remains between the elastomeric annular seal of the first seal/sleeve combination and the elastomeric annular seal of the second seal/sleeve combination. When deployed in an appropriately sized tubular, the seals back each other up to redundantly seal positively against annular fluid flow from either direction between the cylindrical mounting surface and the tubular.

In another embodiment of the invention, there is provided a cleaning device for tubulars which has been fitted with an elastomeric seal, seal/sleeve or stack of seal/sleeves as described hereinabove. The device comprises an inner tubular member, an end piece, an outer tubular member, and the elastomeric seal, seal/sleeve or stack of seal/sleeves. The inner tubular member has an inner tubular member inner bore formed therethrough. The inner tubular member comprises a housing formed on a first portion thereof, a first connection end adjacent the housing, and a second connection end opposite from the first connection end. The end piece is disposed on the second connection end of the inner tubular member. The outer tubular member is slidably disposed about the inner tubular member and is movable from a first position against the housing to a second position adjacent the end piece. The outer tubular member has a first end a second end and forms a flow path from the first end to the second end. The flow path formed through the outer tubular member provides fluid communication between the first end of the outer tubular member and the second end of the outer tubular member except when the outer tubular member is in the first position. The seal, seal/sleeve or stack of seal/sleeves is disposed about the outer tubular member.

### BRIEF DESCRIPTION OF THE DRAWINGS

FIG. 1 is a longitudinal sectional view of a seal/sleeve combination in accordance with an embodiment of the invention.

FIG. 2 is a longitudinal sectional view of a cleaner for tubulars on which a pair of seal/sleeve combinations as in FIG. 1 have been deployed.

FIG. 3 is a longitudinal sectional view of a cleaner as in FIG. 2 in a configuration for annular supply of fluid.

FIG. 4 is a longitudinal section view of a cleaner as in FIG. 2 in a configuration for axial supply of fluid.

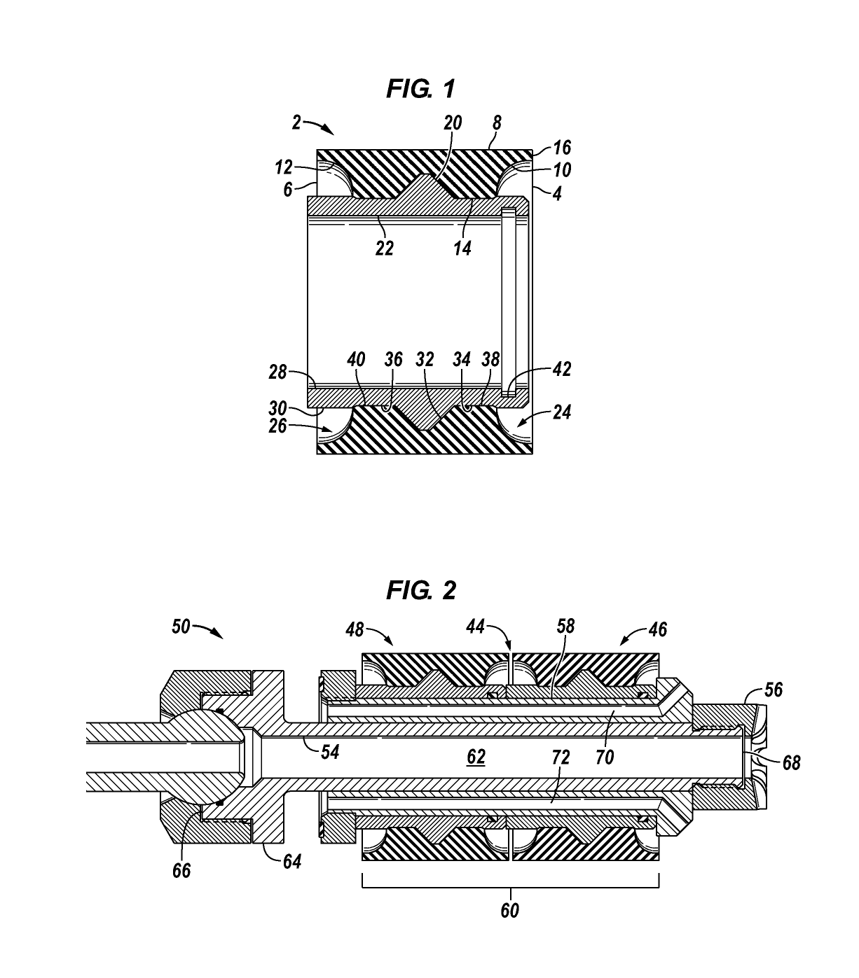

### DETAILED DESCRIPTION OF THE INVENTION

In one embodiment of the invention, there is provided an elastomeric annular seal 2 having a chamfered first end 4 and a chamfered second end 6 and a generally cylindrical outer surface 8 extending between the first end and the second end. The seal has annular cross sections between the first end and the second end and radiused chamfer surfaces 10, 12 when viewed in longitudinal section. The chamfers are radiused over an arc of about 90 degrees extending from an inner surface 14 of the elastomeric annular seal to an end surface 16. Each of the first end and the second end of the seal define a deformable annular lip which face in opposite directions.

The seal is sized to fit its application. It has a length, an outside diameter, and an inside diameter. The length to outside diameter ratio is often in the range of 0.5:1 to 5:1 and the inside diameter to outside diameter ratio is often in the range of 1:1.05 to 1:1.5. The seal can be formed from a wide range of elastomeric materials. Polyurethane having a durometer of about 80 has been used with good results.

In the illustrated embodiment, the inside surface of the seal defines an annular groove 20 which is used to help located the seal when mounted.

In another embodiment of the invention, the elastomeric annular seal is mounted on a rigid sleeve 22. The seal has annular cross sections to fit the sleeve and the chamfers are radiused when viewed in longitudinal section so that the radiused chamfered ends of the elastomeric annular seal together with the outside surface of the rigid sleeve form annularly shaped cups 24, 26. Fluid pressure in the cup will expand the seal against the inside wall of a tubular when the seal/sleeve is appropriately sized for the tubular. The sleeve has a generally cylindrical inside surface 28, and an outside surface 30. The elastomeric annular seal is sealingly mounted to the outside surface of the rigid sleeve.

Where the annular seal is provided with an annular groove, the outside surface of the rigid seal can define an annular ridge 32 received by the groove. If desired, the rigid sleeve can further define a pair of annular grooves 34, 36, one on each side of the annular ridge, and the elastomeric seal further defines a pair of annular ridges, 38, 40 one on each side of the annular groove, the pair of annular ridges being received by the pair of annular grooves. The generally cylindrical inside surface of the rigid sleeve can be further provided with an annular recess 42 near the first end for receipt of an annular seal, for example, an O-ring.

In a further embodiment of the invention, the seal/sleeve ends are slightly asymmetric. The first end of the rigid sleeve is slightly recessed with respect to a first end of the elastomeric annular seal, and the second end of the rigid sleeve slightly protrudes with respect to the second end of the elastomeric seal. When first and second such seal/sleeve combinations are mounted in a stack on a cylindrical surface with the rigid sleeves in abutting relationship, first end to second end, (See FIG. 2) an annular gap 44 remains between the elastomeric annular seal of the first seal/sleeve combination 46 and the elastomeric annular seal 48 of the second seal/sleeve combination. When deployed in an appropriately sized tubular, the seals back each other up to redundantly seal positively against annular fluid flow from either direction between the cylindrical mounting surface and the tubular.

In such an arrangement, the cups opening toward the high pressure end of the tubular are inflated and center the cylindrical body in the tubular. The inflated cups slide relatively snaglessly past the welds because they present a sloping soft shoulder to the welds. The cups opening toward the low pressure end of the tubular are deflated, and thus have greater clearance over the welds than the inflated cups. These factors help provide the inventive seals with long life.

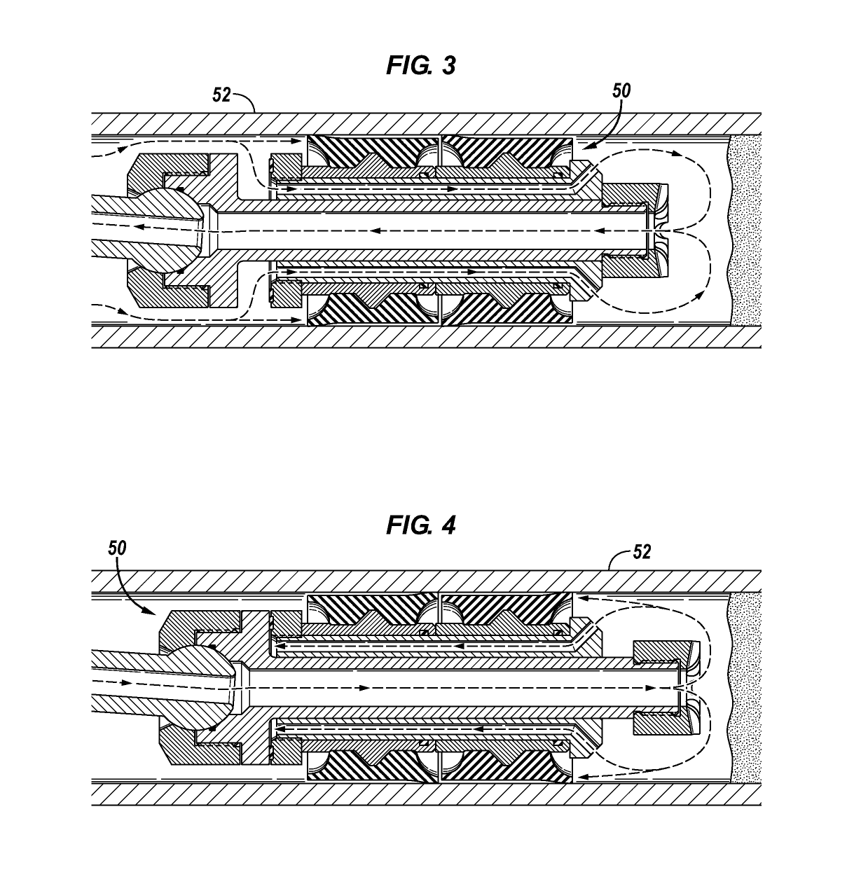

In another embodiment of the invention, there is provided a cleaning device 50 for tubulars 52 which has been fitted with an elastomeric seal, seal/sleeve or stack of seal/sleeves as described hereinabove. The device comprises an inner tubular member 54, an end piece 56 which can be, for example, a nozzle or deflector, an outer tubular member 58, and the elastomeric seal, seal/sleeve or stack of seal/sleeves 60. The inner tubular member has an inner tubular member inner bore 62 formed therethrough. The inner tubular member comprises a housing 64 formed on a first portion thereof, a first connection end 66 adjacent the housing, and a second connection end 68 opposite from the first connection end. The end piece is disposed on the second connection end of the inner tubular member. The outer tubular member is slidably disposed about the inner tubular member and is movable from a first position against the housing (FIG. 4) to a second position adjacent the end piece (FIG. 3). The outer tubular member has a first end a second end and forms a flow path 70, 72 from the first end to the second end. The flow path formed through the outer tubular member provides fluid communication between the first end of the outer tubular member and the second end of the outer tubular member except when the outer tubular member is in the first position (FIG. 4). The seal, seal/sleeve or stack of seal/sleeves is disposed about the outer tubular member.

What is claimed is:

1. An elastomeric annular seal having a chamfered first end and a chamfered second end and a generally cylindrical outer surface extending between the first end and the second end.

2. An elastomeric annular seal as in claim 1 having annular cross sections between the first end and the second end and radiused chamfers when viewed in longitudinal section.

3. An elastomeric annular seal as in claim 2 having a length, an outside diameter, and an inside diameter wherein the length to outside diameter ratio is in the range of 0.5:1 to 5:1 and the inside diameter to outside diameter ratio is in the range of 1:1.05 to 1:1.5.

4. An elastomeric annular seal as in claim 2 wherein the chamfers are radiused over an arc of about 90 degrees extending from an inner surface of the elastomeric annular seal to an end surface, wherein the first end and the second end of the elastomeric annular seal define deformable annular lips facing in opposite directions.

5. An elastomeric annular seal as in claim 2 having an inside surface which defines an annular groove.

6. An elastomeric annular seal as in claim 2 further comprising, in combination, a rigid sleeve having a generally cylindrical inside surface, and an outside surface, said elastomeric annular seal being sealingly mounted to the outside surface of the rigid sleeve so that the radiused chamfered ends of the elastomeric annular seal together with the outside surface of the rigid sleeve form annularly shaped cups.

7. A seal/sleeve combination as in claim 6, wherein the annular seal has an inside surface which defines an annular groove, and the outside surface of the rigid seal defines an annular ridge received by the groove.

8. A seal/sleeve combination as in claim 6, wherein the rigid sleeve further defines a pair of annular grooves, one on each side of the annular ridge, and the elastomeric seal further defines a pair of annular ridges, one of each side of the annular groove, said pair of annular ridges being received by said pair of annular grooves.

9. A seal/sleeve combination as in claim 6, wherein the rigid sleeve has a first end, a second end, and a length between the ends, the length of the rigid sleeve being about the same as the length of the elastomeric annular seal, the first end of the rigid sleeve being slightly recessed with respect to the first end of the elastomeric annular seal, the second end of the rigid sleeve slightly protruding with respect to the second end of the elastomeric seal.

10. A seal/sleeve combination as in claim 9, wherein the generally cylindrical inside surface of the rigid sleeve has an annular recess near the first end for receipt of an annular seal.

11. Apparatus comprising first and second seal/sleeve combinations as in claim 9, mounted on a cylindrical surface with the rigid sleeves in abutting relationship, first end to second end, to define an annular gap between the elastomeric annular seal of the first seal/sleeve combination and the elastomeric annular seal of the second seal/sleeve combination.

12. A cleaning device for tubulars, said device comprising
a. an inner tubular member having an inner tubular member inner bore formed therethrough, wherein the inner tubular member comprises
i. a housing formed on a first portion thereof,
ii. a first connection end adjacent the housing, and
iii. a second connection end opposite from the first connection end,
b. an end piece disposed on the second connection end of the inner tubular member,
c. an outer tubular member slidably disposed about the inner tubular member and movable from a first position against the housing to a second position adjacent the end piece, said outer tubular member having a first end a second end and forming a flow path from the first end to the second end, wherein the flow path formed through the outer tubular member provides fluid communication between the first end of the outer tubular member and the second end of the outer tubular member except when the outer tubular member is in the first position, and
d. an elastomeric annular seal according to claim 1 disposed about the outer tubular member.

13. A cleaning device for tubulars, said device comprising
a. an inner tubular member having an inner tubular member inner bore formed therethrough, wherein the inner tubular member comprises
i. a housing formed on a first portion thereof,
ii. a first connection end adjacent the housing, and
iii. a second connection end opposite from the first connection end,
b. an end piece disposed on the second connection end of the inner tubular member,
c. an outer tubular member slidably disposed about the inner tubular member and movable from a first position against the housing to a second position adjacent the end piece, said outer tubular member having a first end a second end and forming a flow path from the first end to the second end, wherein the flow path formed through the outer tubular member provides fluid communication between the first end of the outer tubular member and the second end of the outer tubular member except when the outer tubular member is in the first position, and
d. an elastomeric annular seal combination according to claim 6 disposed about the outer tubular member.

14. A cleaning device for tubulars, said device comprising
a. an inner tubular member having an inner tubular member inner bore formed therethrough, wherein the inner tubular member comprises
i. a housing formed on a first portion thereof,
ii. a first connection end adjacent the housing, and
iii. a second connection end opposite from the first connection end,
b. an end piece disposed on the second connection end of the inner tubular member,
c. an outer tubular member slidably disposed about the inner tubular member and movable from a first position against the housing to a second position adjacent the end piece, said outer tubular member having a first end a second end and forming a flow path from the first end to the second end, wherein the flow path formed through the outer tubular member provides fluid communication between the first end of the outer tubular member and the second end of the outer tubular member except when the outer tubular member is in the first position, and
d. first and second elastomeric annular seal combinations according to claim 9 disposed about the outer tubular member with the rigid sleeves in abutting first end to second end relationship to define a gap between the elastomeric annular seals ends.
